(19) United States
(12) Patent Application Publication
(10) Pub. No.: US 2023/0367567 A1
(43) Pub. Date: Nov. 16, 2023

(54) Concept for Evaluating Hardware Tracing Records

(71) Applicant: Intel Corporation, Santa Clara, CA (US)

(72) Inventor: Stanislav BRATANOV, Portland, OR (US)

(21) Appl. No.: 18/359,962

(22) Filed: Jul. 27, 2023

(51) Int. Cl. G06F 8/41; G06F 8/52

(52) U.S. Cl. CPC G06F 8/445; G06F 8/52

(57) ABSTRACT

Various examples relate to methods, computer programs, non-transitory computer-readable media, apparatuses, devices, computer systems, and a system for evaluating one or more hardware tracing records related to a hardware tracing operation or for processing a piece of software. A method for evaluating one or more hardware tracing records related to a hardware tracing operation comprises obtaining a hardware tracing record, the hardware tracing record comprising a custom information and a memory address within a deterministic distance of an instruction having triggered the hardware tracing record, identifying, based on the memory address within the deterministic distance of the instruction having triggered the hardware tracing record, a binary module containing the instruction, determining, whether a pre-defined identifier is stored at a pre-defined memory address range relative to the memory address within the deterministic distance of the instruction in the binary module, and processing information on the hardware tracing record if the pre-defined identifier is stored at the pre-defined memory address range relative to the memory address within the deterministic distance of the instruction.

### BACKGROUND

Hardware Tracing is the process of capturing data that illustrates how certain hardware and software components are operating, executing, and performing in the system. Hardware tracing can be done by many components, e.g., processors, buses, or accelerators, and is widely used across the industry for debug, performance monitoring, telemetry, and security purposes. Some examples of hardware tracing include Instruction Based Sampling (IBS) by AMD (AMD is a trademark of Advanced Micro Devices, Inc), and Embedded Trace Macrocell by Arm® (Arm is a registered trademark of Arm Limited (or its subsidiaries) in the US and/or elsewhere) and the Program Trace Macrocell.

Intel's flagship publicly available hardware tracing technology is Processor Trace (PT). It is a branch-tracing technology that is also capable of saving timing and frequency change information, as well as information on transitioning between different power states and modes of operation. PT can store the traced data into a memory buffer or stream the traced data via the USB (Universal Serial Bus). PT is used by many customers through Intel® VTune Profiler or open-source tools, like Linux perf, or in-house tools (Intel® is a trademark of Intel Corporation or its subsidiaries). The customers range from finance and trading companies to cloud service providers.

PT is designed to be extensible, and one of the very useful extensions is the ability to record software-provided information. That enables any software agent—applications, runtime libraries, drivers, operating system kernel, BIOS (Basic Input/Output System), processor microcode, etc. —to record any information about its performance, usage statistics, operating mode, error logs, etc. by simply executing a PTWRITE instruction, and make that information available to analysis tools whenever needed. The cost of such tracing is negligible, and when no analysis tool is running, all PTWRITE instructions effectively turn into a NOP (No Operation). The instant application is not intended to work solely with PT but also with any tracing technology, including those having the ability to record information.

### BRIEF DESCRIPTION OF THE FIGURES

Some examples of apparatuses and/or methods will be described in the following by way of example only, and with reference to the accompanying figures, in which:

FIG. 1a shows a flow chart of an example of a method for evaluating one or more hardware tracing records related to a hardware tracing operation;

FIG. 1b shows a schematic diagram of an example of an apparatus or device for evaluating one or more hardware tracing records related to a hardware tracing operation, of a computer system comprising such an apparatus or device, and of a system;

FIG. 2a shows a flow chart of an example of a method for processing a piece of software;

FIG. 2b shows a schematic diagram of an example of an apparatus or device for processing a piece of software, of a computer system comprising such an apparatus or device, and of a system;

FIG. 3 shows a code example for emitting records into a hardware data stream;

FIG. 4 shows an example of a sequence of timing and iteration records; and

FIG. 5 shows a flow diagram of an example of a record decoding and interpretation process.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

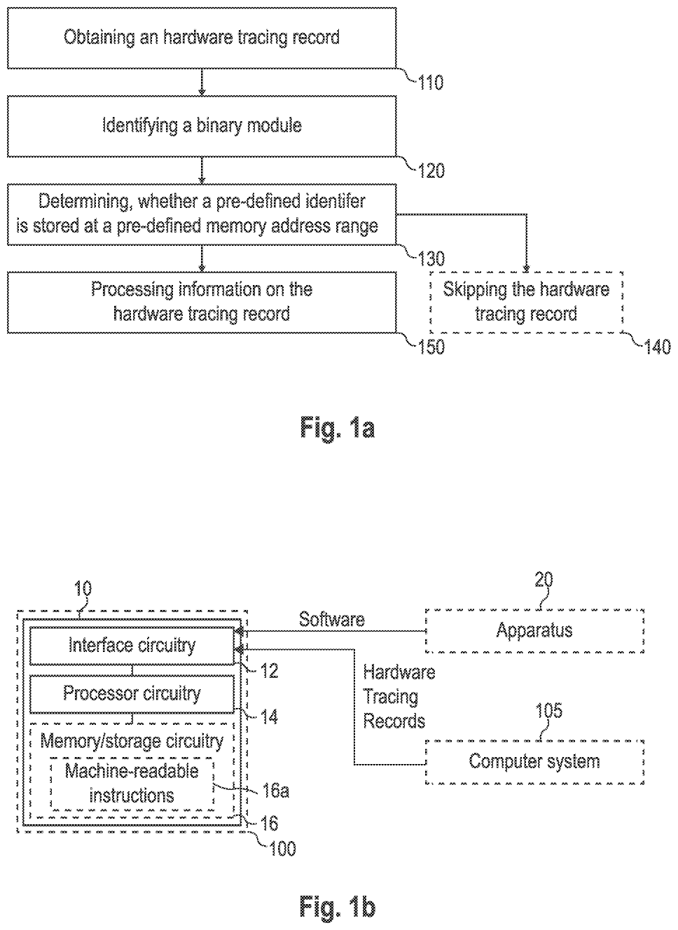

FIG. 1a shows a flow chart of an example of a method for evaluating one or more hardware tracing records related to a hardware tracing operation. The method comprises obtaining 110 a hardware tracing record. The hardware tracing record comprises a custom information and a memory address within a deterministic distance of an instruction having triggered the hardware tracing record. The method comprises identifying 120, based on the memory address within the deterministic distance of the instruction having triggered the hardware tracing record, a binary module containing the instruction. The method comprises determining 130, whether a pre-defined identifier is stored at a pre-defined memory address range relative to the memory address within the deterministic distance of the instruction in the binary module. The method comprises processing 150 information on the hardware tracing record if the pre-defined identifier is stored at the pre-defined memory address range relative to the memory address within the deterministic distance of the instruction. For example, the method may be a computer-implemented method, e.g., a method being performed by a computer system such as a computer system 100 (or apparatus 10 or device 10 of computer system 100) shown in FIG. 1b.

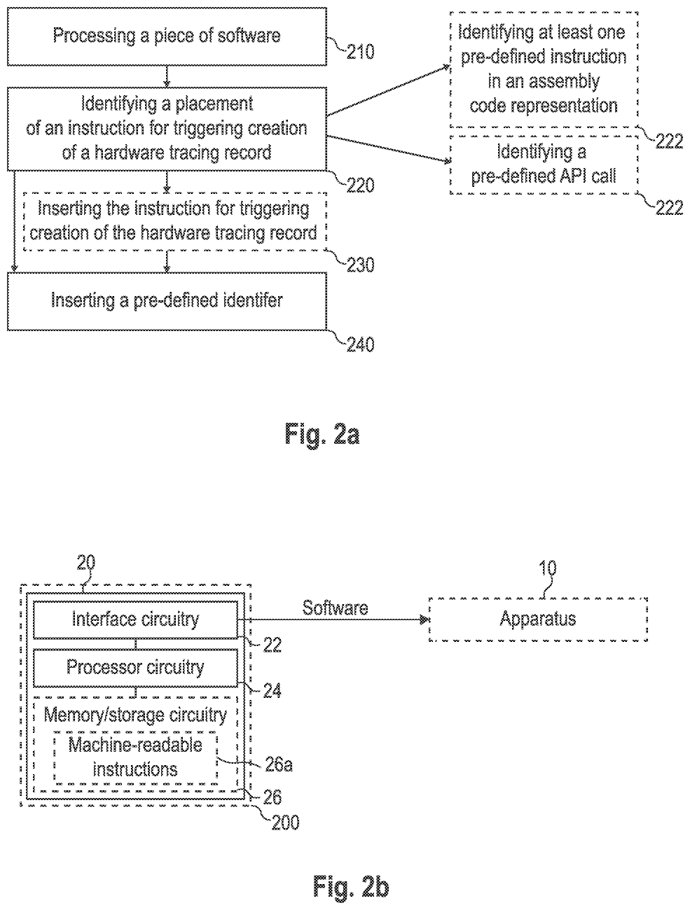

FIG. 1b shows a schematic diagram of an example of a corresponding apparatus 10 or device 10 for evaluating the one or more hardware tracing records related to the hardware tracing operation. The apparatus 10 comprises circuitry to provide the functionality of the apparatus 10. For example, the circuitry of the apparatus 10 may be configured to provide the functionality of the apparatus 10. For example, the apparatus 10 of FIG. 1b comprises interface circuitry 12, processor circuitry 14 and (optional) memory/storage circuitry 16. For example, the processor circuitry 14 may be coupled with the interface circuitry 12 and with the memory/storage circuitry 16. For example, the processor circuitry 14 may provide the functionality of the apparatus, in conjunction with the interface circuitry 12 (for communicating with another computer system or entity, such as another computer system 105, a computer system 200 (shown in FIG. 2b), or an apparatus/device 20), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1b comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions 16a, e.g., within the memory or storage circuitry 16 or means for storing information 16, as shown in FIG. 1b. The processor circuitry 14 or means for processing 14 is to perform the method of FIG. 1a, e.g., in conjunction with the interface circuitry 12, and the memory/storage circuitry 16.

FIG. 1b further shows a computer system 100 comprising the apparatus 10 or device 10. FIG. 1b further shows a system comprising the apparatus/device 10 and the apparatus 20/device 20 (which will be discussed in connection with FIGS. 2a and 2b).

Various examples of the present disclosure relate to hardware tracing records, and in particular to the evaluation of hardware tracing records. In software development, it is common practice to do performance analysis with the help of performance analysis tools that monitor the running of the software being developed at runtime, so the developer can identify performance bottlenecks and identify performance- or deadlock-related bugs. As an alternative, or additionally, code instrumentation is being used to log information during execution of the software being developed, so the developer can identify the code paths taken (and values of variables) by the software during testing. However, both performance monitoring via the development environment and code instrumentation has performance penalties, which result in a limited applicability of these techniques for real-world performance monitoring.

Processor manufacturers have developed hardware tracing techniques to reduce or minimize the computational overhead required for doing performance monitoring. Using these techniques, the impact on performance of the actual software is reduced, as specific hardware implementations take care of logging the desired information. However, in various implementations, such as Intel® Processor Trace (PT) to keep the overhead low, the amount of information being stored is also limited, so there is no performance impact on the running application (to be profiled). In general, in many implementations, such as PT, the information being stored includes a custom information (which is the information that the hardware tracing instruction is told to store), and a memory address that points to the instruction having triggered the hardware tracing record.

While the custom information and the address provide developers with valuable insights regarding execution of their program, their utility is limited in real-world scenarios, such as cloud server scenarios, where a large number of applications are executed at the same time, e.g., as microservices on top of containers. If multiple applications use hardware tracing, it is non-trivial to keep the hardware tracing records separate, such that the monitoring is based only on hardware tracing records of a specific application (or binary module thereof). While the custom information can also be used to encode an identifier of the application, for performance reasons, the custom information being stored is often limited—to 4 byte or 8 byte in the case of PT, for example, such that this course of action severely reduces the amount of usable custom information.

In the proposed concept, another approach is taken. Instead of assuming a single-application debugging scenario, and instead of encoding an identifier into the custom information, a pre-defined identifier is stored in proximity to the instruction having triggered the hardware tracing record. Using the address being stored, first, the binary module (i.e., a part of the software being traced) is identified. The binary module is then scanned (in proximity of the instruction having triggered the hardware tracing record) to detect a pre-defined identifier, which allows determining that a) the hardware tracing record is triggered by a software supporting the proposed technique and b) the context from which the custom information was written. For example, if multiple types of information are stored as separate custom information, such as timestamps and iteration counters, different pre-defined identifiers may be used to enable an analysis tool to differentiate between the different records. Thus, a method for evaluating one or more hardware tracing records related to a hardware tracing operation is provided.

The process starts, on the evaluation side, with obtaining 110 the hardware tracing record. For example, the method may be applied to a plurality of hardware tracing records stored in a memory or storage device, e.g., in a pre-defined memory region. Thus, the hardware tracing record may be obtained from the pre-defined memory region. This pre-defined memory region may be a memory region for storing hardware tracing records, e.g., a buffer being used by the respective hardware tracing functionality. For example, the pre-defined memory region may be a processor-specific hardware tracing buffer. Alternatively, the pre-defined memory region may be a memory region being specified by the instruction triggering the hardware tracing record (e.g., if the concept is implemented on Arm® systems). In this case, the pre-defined memory region may be specified by the instruction having triggered the hardware tracing record.

However, the present concept is not limited to local machines. It can also be used for profiling on remote machines or separate hardware (e.g., graphics processing units or other types of accelerators). For example, the method may be applied to a plurality of hardware tracing records retrieved over a transmission channel, such as a network or the Universal Serial Bus (USB), e.g., from computer system 105.

As outlined above, the hardware tracing record comprises a custom information and a memory address. This custom information is the information, such as timestamp or iteration counter, being traced/stored/logged by the software issuing the instruction having triggered the hardware tracing record. The address, on the other hand, can be used to identify the instruction having triggered the hardware tracing record, or at least the binary module comprising the instruction. For example, the memory address within the deterministic distance of the instruction may be one of the exact address of the instruction that triggered the hardware tracing record, the address of the instruction that follows the instruction that triggered the hardware tracing record, or the address of an instruction at a pre-defined distance to the instruction that triggered the hardware tracing record. For example, the deterministic distance may correspond to a deterministic offset in memory address space, i.e., a deterministic memory offset, from the instruction that triggered the hardware tracing record.

Using this address, the binary module can be identified 120. For example, the address may be used to determine a location of the binary module in memory (or storage), e.g., at the time the software comprising the binary module was executed/traced. Using knowledge (e.g., a mapping) on which software (e.g., binary module thereof) was executed where in memory, the software, and binary module thereof, can be identified. For example, the hardware tracing record may further (i.e., in addition to the custom information and address) comprise a timestamp. The act of identifying the binary module may be further based on the timestamp. For example, the timestamp and address may be used to look up the binary module via the aforementioned mapping. In the present context, the binary module may correspond to a function of a piece of software or a basic block of a piece of software. This binary module contains the instruction (or a call of the instruction) have triggered creation of the hardware tracing record.

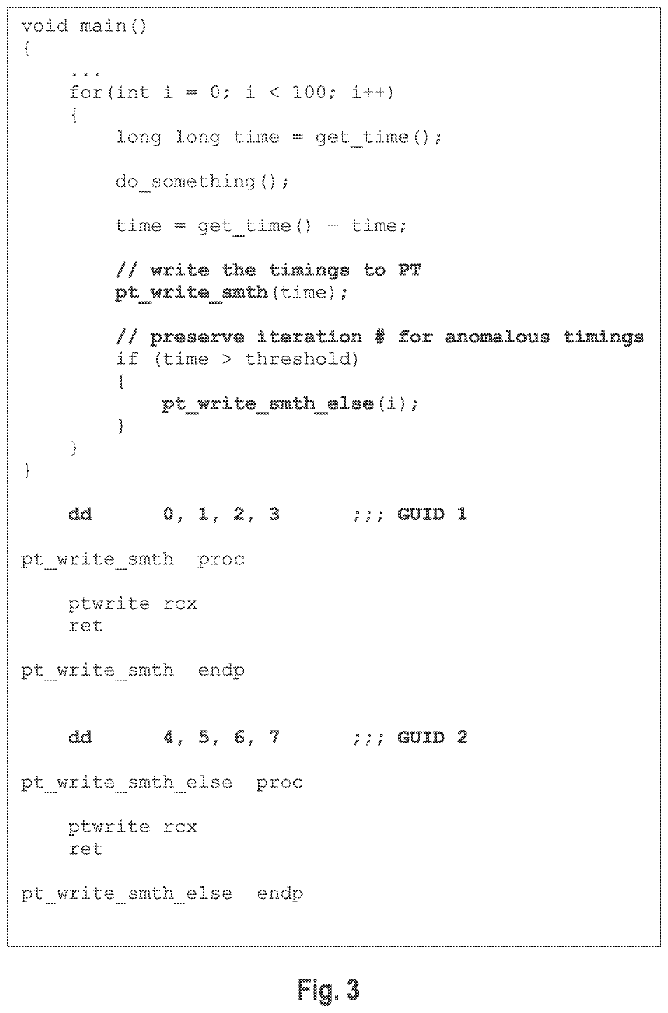

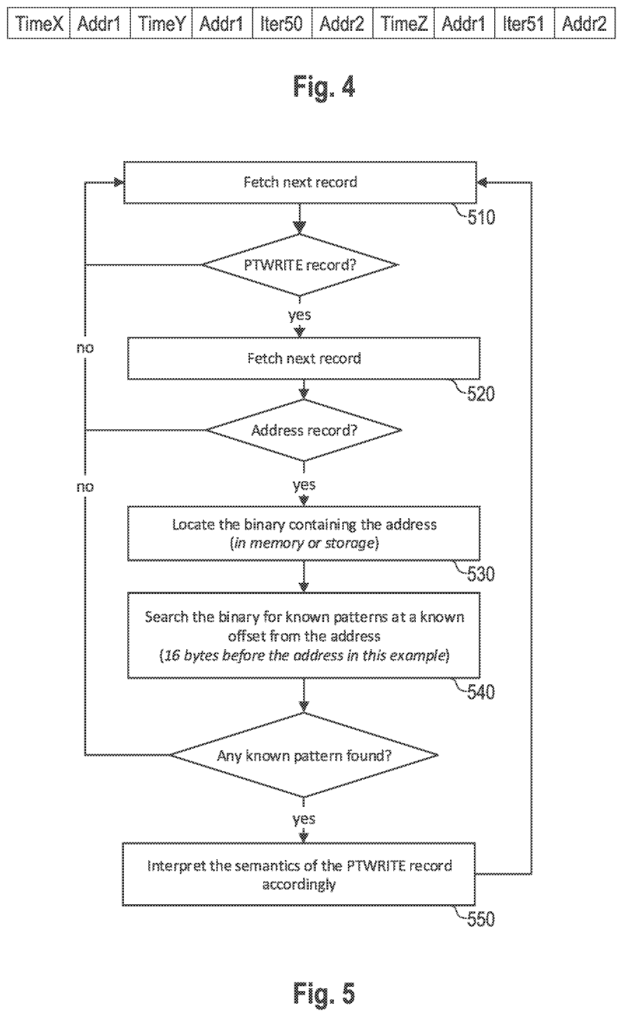

Once the binary module is identified, the pre-defined identifier may be detected in the pre-defined memory address range relative to the memory address within the deterministic distance of the instruction in the binary module, to determine 130, whether a pre-defined identifier is stored at a pre-defined memory address range relative to the memory address within the deterministic distance of the instruction in the binary module. For example, in FIG. 3, the pre-defined identifiers (GUID 1 and GUID 2) are stored just before the procedure definitions of the procedures including the instructions (PTWRITE) triggering creation of the hardware tracing record. In FIG. 3, the “dd” instruction contains the respective pre-defined identifier as operands. To identify the presence of such a (binary) pre-defined identifier, the pre-defined identifier may include a part that is characteristic of such pre-defined identifiers, e.g., a pre-fix or postfix. For example, in FIG. 3, four 32 bit-constants form the pre-defined identifier. One of the four 32-bit constants may be used as part that is characteristic of such pre-defined identifiers, to aid in the detection of the pre-defined identifiers. These pre-defined identifiers are then used in the interpretation of the respective custom information. In some examples, e.g., if the same identifier is only used once, the pre-defined identifier uniquely identifies a specific hardware tracing operation. Additionally, or alternatively, the pre-defined identifier may uniquely identify a piece of software, e.g., uniquely identify a binary module of a piece of software, to simplify keeping apart hardware tracing records of different pieces of software or binary modules. In some examples, the pre-defined identifier specifies a type of information stored in the custom information (e.g., timestamp or iteration counter, in the example of FIG. 4).

The presence (or absence) of the pre-defined identifier is used to determine, whether a hardware tracing record is relevant to the evaluation, as hardware tracing records that are from other hardware tracing operations can be sorted out and skipped. For example, as further shown in FIG. 1a, the method may comprise skipping 140 a hardware tracing record if the determination, whether the pre-defined identifier is stored at the pre-defined memory address range, may be negative. Moreover, if the hardware tracing records deemed relevant are stored in a pre-defined memory region, hardware tracing records outside this region may also be skipped. For example, the method may comprise skipping 140 a hardware tracing record if the hardware tracing record is stored outside the pre-defined memory region. Finally, in some cases, only indirect branches may be of interest with respect to the hardware tracing operation. For example, the hardware tracing record may comprise information on a branch type. The method may comprise skipping 140 the hardware tracing record unless the information on the branch type indicates an indirect branch.

The remaining hardware tracing records may then be processed 150. In some examples, processing 150 the hardware tracing record may comprise analyzing and/or displaying information on the hardware tracing record in a hardware tracing analysis tool or a development environment (e.g., a development graphical user interface). For example, the information on the hardware tracing record may be processed with the custom information and with information on the binary module (and with the pre-defined identifier). For example, the pre-defined identifier may be used to map the custom information to the respective binary module or instructions therein, or to interpret the information contained in the custom information. In some examples, processing 150 the hardware tracing record may comprise storing the hardware tracing record (with the custom information, information on the binary module and the pre-defined identifier), for analysis by a hardware tracing analysis tool or a development environment.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be one of a workstation computer system, a server computer system, a personal computer system, a portable computer system, a mobile device, a smartphone, a tablet computer, or a laptop computer.

More details and aspects of the method, apparatus 10, device 10, computer system 100 and/or system are mentioned in connection with the proposed concept, or one or more examples described above or below (e.g., FIGS. 2a to 5). The method, apparatus 10, device 10, computer system 100 and/or system may comprise one or more additional optional features corresponding to one or more aspects of the proposed concept, or one or more examples described above or below.

FIG. 2a shows a flow chart of an example of a method for processing a piece of software. The method comprises processing 210 the piece of software to identify 220 a placement of one or more instructions for triggering creation of a hardware tracing record. The method comprises inserting 240 into the piece of software, for each instruction of the one or more instructions, a pre-defined identifier at a pre-defined memory address range relative to a memory address within a deterministic distance of the instruction. For example, the method may be a computer-implemented method, e.g., a method being performed by a computer system such as a computer system 200 (or apparatus 20 or device 20 of computer system 200) shown in FIG. 2b.

FIG. 2b shows a schematic diagram of an example of a corresponding apparatus 20 or device 20 for processing the piece of software. The apparatus 20 comprises circuitry to provide the functionality of the apparatus 20. For example, the circuitry of the apparatus 20 may be configured to provide the functionality of the apparatus 20. For example, the apparatus 20 of FIG. 2b comprises interface circuitry 22, processor circuitry 24, (optional) memory/storage circuitry 26. For example, the processor circuitry 24 may be coupled with the interface circuitry 22, with the memory/storage circuitry 26. For example, the processor circuitry 24 may provide the functionality of the apparatus, in conjunction with the interface circuitry 22 (for communicating with another computer system or entity, such as a computer system 100 (shown in FIG. 1b) or an apparatus/device 10), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2b comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions 26a, e.g., within the memory or storage circuitry 26 or means for storing information 26, as shown in FIG. 2b. The processor circuitry 24 or means for processing 24 is to perform the method of FIG. 2a, e.g., in conjunction with the interface circuitry 22, and the memory/storage circuitry 26.

FIG. 2b further shows a computer system 200 comprising such an apparatus 20 or device 20. FIG. 2b further shows a system comprising the apparatus 20 or device 20 (or the computer system 200) and the apparatus 10 or device 10 introduced in connection with FIGS. 1a and/or 1b.

FIGS. 2a and 2b relate to a method, apparatus, and device for processing a piece of software. In contrast to FIGS. 1a and 1b, which relates to the processing of the hardware tracing records, FIGS. 2a and 2b relate to the preparation of the software, e.g., the binaries, with the hardware tracing instructions and corresponding pre-defined identifiers. This can be done, for example, by a development environment, a compiler, or by post-processing the binary of the piece of software.

The method starts with processing 210 the piece of software to identify 220 a placement of one or more instructions for triggering creation of a hardware tracing record. This can be done in various ways. In some examples, identifying 220 the placement may comprise detecting the instructions(s) for triggering creation of a hardware tracing record (in the source code or assembly code). Accordingly, the placement of the one or more instructions may be identified 220 by identifying 222 at least one pre-defined instruction in an assembly code representation (or source code representation) of the piece of software, e.g., in a binary module of the piece of software. Alternatively, identifying 220 the placement may comprise identifying higher-level instructions or settings, e.g., instructions for calling a profiling framework or library, and not the instructions for triggering creation of the hardware tracing record itself. In this case, the placement of the one or more instructions may be identified 220 by identifying 224 a pre-defined application programming interface call (e.g., to a hardware tracing framework or library) in a source code representation of the piece of software during compilation of the piece of software. In some cases, identifying the placement may be done while or prior to inserting the instructions for triggering creation of the hardware tracing record, e.g., according to higher-level instructions, profiling-instructions, breakpoints, variable tracing instructions, etc. in the source code, with the higher-level instructions, profiling-instructions, breakpoints, variable tracing instructions, etc. indicating placement of the instructions. Accordingly, the method may comprise inserting 230 into the software, for each instruction of the one or more instructions, the instruction for triggering creation of a hardware tracing record (e.g., according to the identified placement).

Once placement of the instruction(s) is identified, the pre-defined identifiers (introduced in connection with FIGS. 1a and/or 1b) are inserted. Accordingly, the method comprises inserting, a pre-defined identifier at a pre-defined memory address range relative to a memory address within a deterministic distance of the instruction.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information. For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system may be one of a workstation computer system, a server computer system, a personal computer system, a portable computer system, a mobile device, a smartphone, a tablet computer, or a laptop computer.

More details and aspects of the method, apparatus 20, device 20, computer system 200 and/or system are mentioned in connection with the proposed concept, or one or more examples described above or below (e.g., FIG. 1a to 1b, 3 to 5). The method, apparatus 20, device 20, computer system 200 and/or system may comprise one or more additional optional features corresponding to one or more aspects of the proposed concept, or one or more examples described above or below.

Various examples of the present disclosure relate to a concept (e.g., a method) of sharing hardware tracing capabilities between multiple software agents.

In general, a challenge in hardware tracing as tools generally cannot differentiate between records coming from different software components into the same hardware trace. This may limit the use of hardware tracing techniques, such as PTWRITE.

Some hardware tracing techniques more or less imply a single-agent use. In some cases, hardware tracing techniques may even lack capability to generate software-provided records. This limits a tracing technology to a niche use, in a debug environment, which cannot be deployed on a large scale as a production-level solution. It may block compilers, runtimes, drivers, OS, and BIOS from using instructions like PTWRITE, because they will have to be conditionally turned on and off or inserted through binary instrumentation, which increases support costs and performance overheads.

In some cases, the address of a PTWRITE instruction can be traced (as PT can be configured not only to trace the payload of PTWRITE, but also to store the address of the PTWRITE instruction itself) and use it to differentiate between different records. Differentiating of records through the address of PTWRITE instruction alone is not possible, as multiple tools can try and use the same library to emit records (of totally different semantics) or write records of the same semantics from multiple places within the code.

In the following, an example is given on how a more fine-granular use of hardware tracing, even in production environments, is enabled. Intel PT introduces an instruction (PTWRITE) to store an arbitrary 4- or 8-byte record into the hardware data stream. Intel PT also stores an address (compressed) of the PTWRITE instruction in the same data stream.

In the proposed concept, the software that uses PTWRITE is encouraged to place a distinguishable/unique sequence of bytes at a certain offset from each PTWRITE instruction (e.g., place a globally unique ID (GUID) before, after, or around each PTWRITE). A decoding tool that reads the PT data stream may then fetch a PTWRITE-generated record, then fetch an address of the associated PTWRITE instruction, and then search for a known sequence of bytes (GUID) at a known offset from said address. If the GUID is found, then the record can be safely interpreted. If not, then the record may be skipped.

If a hardware tracing tool is not following this approach and not generating a unique binary sequence before/after its PTWRITEs, it does not affect the operation of the tools following this approach, because their GUIDs will be, with a very high degree of probability, different from the binary sequences of the non-compliant tools, and thus the tools following this approach might not mistake PTWRITE records of non-compliant tools for their own. The proposed concept is equally applicable to any means of storing software-provided records into a hardware data stream, and are not limited to Intel PT.

The proposed concept enables software vendors to publicly expose their tracing solutions and let users benefit from tracing their code without fear of conflicting with other users and tools. For example, an operating system vendor may publish a hypervisor, such as Hyper-V, instrumented with PTWRITEs and help tune software to their virtualization environments. For example, PTWRITEs may be inserted into the operating system kernel and their event tracing infrastructure. Moreover, the proposed concept may be used in open-source tracing frameworks for cloud workloads. For example, the proposed concept may be used to provide low-latency traders with a technique for always-running performance anomaly monitoring systems in their production environments.

The proposed concept may enable wide adoption of hardware tracing techniques, such as Intel PT, for software tracing. This may enable implementation of a highly-performance read performance-monitoring counter instructions that may output performance counter values into PT or other hardware tracing techniques, and compiler-generated instrumentation for debugging.

FIG. 3 shows a code example for emitting records into a hardware data stream (as C-like pseudo-code plus assembly) using the PTWRITE instruction. The code works as follows: the main function is timing some work that it performs in a loop and emits the timings into the PT data stream. If the work takes longer than a certain threshold, then the main function emits the current index of loop iteration—to indicate where that performance anomaly happened. In the code, two GUIDs are stored—GUID 1 (before pt_write_smth), and GUID 2 (before pt_write_smth_else). Separate PTWRITE instances are used for different semantics of the records.

In effect, the hardware trace will comprise an arbitrary sequence of records containing timings and iterations (plus PTWRITE instruction addresses), as shown in FIG. 4. FIG. 4 shows an example of an (arbitrary) sequence of timing (TimeX, TimeY, TimeZ) and iteration records (Iter50, Iter51) and addresses (Addr1, Addr2). How can an analysis tool tell time records from iteration records? In other approaches, the records can be told apart by the addresses of PTWRITEs: time records were emitted by PTWRITE at address 1 (address of pt_write_smth function), and iteration records were emitted at address 2 (address of pt_write_smth_else function). The problem is that when the library, implementing pt_write_smth . . . functions, gets mapped to different addresses or when the code recompiles, the analysis tools have to be recompiled and the list of addresses updated. That is not sustainable.

The proposed concept may address this challenge. The analysis tool may look up a pre-defined area, e.g., the 16 bytes before the address of the PTWRITE instruction. In the example of FIG. 3, those 16 bytes contain a globally unique ID, by which the tool can identify timings records (GUID 0x00000003000000020000000100000000) and iteration records (GUID 0x00000007000000060000000500000004). That way, no matter how many copies of the library with pt_write_smth . . . functions are mapped to which address ranges, any tool can differentiate the semantics of records and tell timings from iterations.

FIG. 5 visualizes the decoding process. FIG. 5 shows a flow diagram of an example of a record decoding and interpretation process. The flow starts with fetching 510 a (next) record. If the record is a PTWRITE record, the next record is fetched 520. If the record is an address record, the binary containing the address is located 530 (in memory or storage), and the binary is searched 540 for known patterns at a known offset from the address (16 bytes before the address in the example of FIG. 3). If a known pattern is found, the semantics of the PTWRITE record are interpreted accordingly.

By the nature of Intel PT trace compression, PT trace decoding tools may store a map of executable modules and have access to the binaries to decode the control flow trace correctly. That is why looking up the PTWRITE addresses and searching the binaries for GUIDs might not constitute a new analysis step and therefore might not complicate the decoding. On the contrary, it may benefit from existing trace decoding infrastructure and does not add any noticeable performance overhead.

The proposed concept is not limited to Intel's PT technology. For example, the proposed concept may be used to enable universal tracing capabilities, similar to Intel's PTWRITE, in ARM's Embedded Trace Macrocell (ETM) without changing a single hardware gate, purely by software means. ARM's ETM provides code and data tracing capabilities. Intel PT took a different approach and does not provide for data tracing, because data tracing is considered expensive—in terms of memory bandwidth, data transmission rates, trace sizes, performance overheads. Instead, the PTWRITE instruction was introduced as a means of tracing any kind of information. Using the proposed technique, the data rates and overheads may be greatly reduced. For this purpose, filtering of a data address range may be setup to trace only data written to one dedicated range or address. In addition, tracing of indirect branches only might be enabled. Dedicated branch targets in the code may be created that will write anything to the data address range being traced. Each branch target may be pre- or post-fixed with a unique ID, so that the code can output arbitrary data values and convey their semantics by calling a specific branch target. As a result, ARM ETM hardware may collect a target branch address and a data value, for example, written to memory with an ST instruction (there is no need for a custom operation), and the decoding software may fetch that ST instruction from the disassembly, at the traced branch target address, find the ID next to it, and interpret the output data value correctly—by following the proposed concept.

The proposed concept may be used to improve debuggability and traceability for different systems by lowering traced data rates and required bandwidth by orders of magnitude in a cheap way, through modifying software and not changing existing hardware. The proposed concept may expand the tracing functionality of different systems from primarily being used for debugging to universal tracing that can be used for performance monitoring and anomaly detection.

The proposed concept may be used in various tools (e.g., a debugger, performance monitoring, or tracing tool, a compiler, or a library) to differentiate the tool's own records from the rest of records, and thus can be reliably used in the production environment. As that would be its clear competitive advantage.

The proposed concept is based on using a unique binary sequence around the instruction that generates a trace record (e.g., PTWRITE).

More details and aspects of the concept of sharing hardware tracing capabilities between multiple software agents are mentioned in connection with the proposed concept or one or more examples described above or below (e.g., FIG. 1a to 2b). The concept of sharing hardware tracing capabilities between multiple software agents may comprise one or more additional optional features corresponding to one or more aspects of the proposed concept or one or more examples described above or below.

An example (e.g., example 1) relates to a method for evaluating one or more hardware tracing records related to a hardware tracing operation, the method comprising obtaining (110) a hardware tracing record, the hardware tracing record comprising a custom information and a memory address within a deterministic distance of an instruction having triggered the hardware tracing record. The method comprises identifying (120), based on the memory address within the deterministic distance of the instruction having triggered the hardware tracing record, a binary module containing the instruction. The method comprises determining (130), whether a pre-defined identifier is stored at a pre-defined memory address range relative to the memory address within the deterministic distance of the instruction in the binary module. The method comprises processing (150) information on the hardware tracing record if the pre-defined identifier is stored at the pre-defined memory address range relative to the memory address within the deterministic distance of the instruction.

Another example (e.g., example 2) relates to a previously described example (e.g., example 1) or to any of the examples described herein, further comprising that the memory address within the deterministic distance of the instruction is one of the exact address of the instruction that triggered the hardware tracing record, the address of the instruction that follows the instruction that triggered the hardware tracing record, or the address of an instruction at a pre-defined distance to the instruction that triggered the hardware tracing record.

Another example (e.g., example 3) relates to a previously described example (e.g., one of the examples 1 to 2) or to any of the examples described herein, further comprising that the method comprises skipping (140) a hardware tracing record if the determination, whether the pre-defined identifier is stored at the pre-defined memory address range, is negative.

Another example (e.g., example 4) relates to a previously described example (e.g., one of the examples 1 to 3) or to any of the examples described herein, further comprising that the information on the hardware tracing record is processed with the custom information and with information on the binary module.

Another example (e.g., example 5) relates to a previously described example (e.g., one of the examples 1 to 4) or to any of the examples described herein, further comprising that the hardware tracing record further comprises a timestamp, with the act of identifying the binary module being further based on the timestamp.

Another example (e.g., example 6) relates to a previously described example (e.g., one of the examples 1 to 5) or to any of the examples described herein, further comprising that pre-defined identifier uniquely identifies a specific hardware tracing operation.

Another example (e.g., example 7) relates to a previously described example (e.g., one of the examples 1 to 5) or to any of the examples described herein, further comprising that pre-defined identifier uniquely identifies a piece of software.

Another example (e.g., example 8) relates to a previously described example (e.g., example 7) or to any of the examples described herein, further comprising that pre-defined identifier uniquely identifies a binary module of a piece of software.

Another example (e.g., example 9) relates to a previously described example (e.g., one of the examples 1 to 8) or to any of the examples described herein, further comprising that the method is applied to a plurality of hardware tracing records stored in a pre-defined memory region.

Another example (e.g., example 10) relates to a previously described example (e.g., example 9) or to any of the examples described herein, further comprising that the pre-defined memory region is a processor-specific hardware tracing buffer.

Another example (e.g., example 11) relates to a previously described example (e.g., example 9) or to any of the examples described herein, further comprising that the pre-defined memory region is specified by the instruction having triggered the hardware tracing record.

Another example (e.g., example 12) relates to a previously described example (e.g., example 11) or to any of the examples described herein, further comprising that the method comprises skipping (140) a hardware tracing record if the hardware tracing record is stored outside the pre-defined memory region.

Another example (e.g., example 13) relates to a previously described example (e.g., one of the examples 1 to 12) or to any of the examples described herein, further comprising that the method is applied to at least one of a plurality of hardware tracing records retrieved over a transmission channel, and a plurality of hardware tracing records stored in a memory or storage device.

Another example (e.g., example 14) relates to a previously described example (e.g., one of the examples 1 to 13) or to any of the examples described herein, further comprising that the hardware tracing record comprises information on a branch type, with the method comprising skipping (140) the hardware tracing record unless the information on the branch type indicates an indirect branch.

Another example (e.g., example 15) relates to a previously described example (e.g., one of the examples 1 to 14) or to any of the examples described herein, further comprising that the binary module corresponds to a function of a piece of software or a basic block of a piece of software.

An example (e.g., example 16) relates to a method for processing a piece of software, the method comprising processing (210) the piece of software to identify (220) a placement of one or more instructions for triggering creation of a hardware tracing record. The method comprises inserting (240) into the piece of software, for each instruction of the one or more instructions, a pre-defined identifier at a pre-defined memory address range relative to a memory address within a deterministic distance of the instruction.

Another example (e.g., example 17) relates to a previously described example (e.g., example 16) or to any of the examples described herein, further comprising that the placement of the one or more instructions is identified (220) by identifying (222) at least one pre-defined instruction in an assembly code representation of the piece of software.

Another example (e.g., example 18) relates to a previously described example (e.g., example 16) or to any of the examples described herein, further comprising that the placement of the one or more instructions is identified (220) by identifying (224) a pre-defined application programming interface call in a source code representation of the piece of software during compilation of the piece of software.

Another example (e.g., example 19) relates to a previously described example (e.g., one of the examples 16 to 18) or to any of the examples described herein, further comprising that the method comprises inserting (230) into the software, for each instruction of the one or more instructions, the instruction for triggering creation of a hardware tracing record.

An example (e.g., example 20) relates to an apparatus (10) comprising interface circuitry (12), machine-readable instructions and processor circuitry (14) to execute the machine-readable instructions to perform the method according to one of the examples 1 to 15 (or according to any other example).

An example (e.g., example 21) relates to an apparatus (20) comprising interface circuitry (22), machine-readable instructions and processor circuitry (24) to execute the machine-readable instructions to perform the method according to one of the examples 16 to 19 (or according to any other example).

An example (e.g., example 22) relates to an apparatus (10) comprising processor circuitry (14) configured to perform the method according to one of the examples 1 to 15 (or according to any other example).

An example (e.g., example 23) relates to an apparatus (20) comprising processor circuitry (24) configured to perform the method according to one of the examples 16 to 19 (or according to any other example).

An example (e.g., example 24) relates to an apparatus (10) comprising means for processing (14) for performing the method according to one of the examples 1 to 15 (or according to any other example).

An example (e.g., example 25) relates to an apparatus (20) comprising means for processing (24) for performing the method according to one of the examples 16 to 19 (or according to any other example).

An example (e.g., example 26) relates to an apparatus (10) comprising interface circuitry (12), machine-readable instructions and processor circuitry (14) to execute the machine-readable instructions to obtain a hardware tracing record, the hardware tracing record comprising a custom information and a memory address within a deterministic distance of an instruction having triggered the hardware tracing record. The processor circuitry is to execute the machine-readable instructions to identify, based on the memory address within the deterministic distance of the instruction having triggered the hardware tracing record, a binary module containing the instruction. The processor circuitry is to execute the machine-readable instructions to determine, whether a pre-defined identifier is stored at a pre-defined memory address range relative to the memory address within the deterministic distance of the instruction in the binary module. The processor circuitry is to execute the machine-readable instructions to process information on the hardware tracing record if the pre-defined identifier is stored at the pre-defined memory address range relative to the memory address within the deterministic distance of the instruction.

An example (e.g., example 27) relates to an apparatus (20) comprising interface circuitry (22), machine-readable instructions and processor circuitry (24) to execute the machine-readable instructions to process the piece of software to identify a placement of one or more instructions for triggering creation of a hardware tracing record. The processor circuitry is to execute the machine-readable instructions to insert into the piece of software, for each instruction of the one or more instructions, a pre-defined identifier at a pre-defined memory address range relative to a memory address within a deterministic distance of the instruction.

An example (e.g., example 28) relates to a computer system (100) comprising the apparatus (10) or device (10) according to one of the examples 20, 22, 24 or 26 (or according to any other example).

An example (e.g., example 29) relates to a computer system (100) comprising the apparatus (20) or device (20) according to one of the examples 21, 23, 25 or 27 (or according to any other example).

An example (e.g., example 30) relates to a system comprising the apparatus (10) or device (10) according to one of the examples 20, 22, 24 or 26 (or according to any other example) and the apparatus (20) or device (20) according to one of the examples 21, 23, 25 or 27 (or according to any other example).

An example (e.g., example 31) relates to a non-transitory, computer-readable medium comprising a program code that, when the program code is executed on a processor, a computer, or a programmable hardware component, causes the processor, computer, or programmable hardware component to perform the method of one of the examples 1 to 15 (or according to any other example) or the method of one of the examples 16 to 19 (or according to any other example).

An example (e.g., example 32) relates to a non-transitory, computer-readable medium comprising a program code that, when the program code is executed on a processor, a computer, or a programmable hardware component, causes the processor, computer, or programmable hardware component to obtain a hardware tracing record, the hardware tracing record comprising a custom information and a memory address within a deterministic distance of an instruction having triggered the hardware tracing record. The program code is to cause the processor, computer, or programmable hardware component to identify, based on the memory address within the deterministic distance of the instruction having triggered the hardware tracing record, a binary module containing the instruction. The program code is to cause the processor, computer, or programmable hardware component to determine, whether a pre-defined identifier is stored at a pre-defined memory address range relative to the memory address within the deterministic distance of the instruction in the binary module. The program code is to cause the processor, computer, or programmable hardware component to process information on the hardware tracing record if the pre-defined identifier is stored at the pre-defined memory address range relative to the memory address within the deterministic distance of the instruction.

An example (e.g., example 33) relates to a non-transitory, computer-readable medium comprising a program code that, when the program code is executed on a processor, a computer, or a programmable hardware component, causes the processor, computer, or programmable hardware component to process the piece of software to identify a placement of one or more instructions for triggering creation of a hardware tracing record. The program code is to cause the processor, computer, or programmable hardware component to insert into the piece of software, for each instruction of the one or more instructions, a pre-defined identifier at a pre-defined memory address range relative to a memory address within a deterministic distance of the instruction.

An example (e.g., example 34) relates to a non-transitory machine-readable storage medium including program code, when executed, to cause a machine to perform the method of one of the examples 1 to 15 (or according to any other example) or the method of one of the examples 16 to 19 (or according to any other example).

An example (e.g., example 35) relates to a computer program having a program code for performing the method of one of the examples 1 to 15 (or according to any other example) or the method of one of the examples 16 to 19 (or according to any other example) when the computer program is executed on a computer, a processor, or a programmable hardware component.

An example (e.g., example 36) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for evaluating one or more hardware tracing records related to a hardware tracing operation, the method comprising:
obtaining a hardware tracing record, the hardware tracing record comprising a custom information and a memory address within a deterministic distance of an instruction having triggered the hardware tracing record;
identifying, based on the memory address within the deterministic distance of the instruction having triggered the hardware tracing record, a binary module containing the instruction;
determining, whether a pre-defined identifier is stored at a pre-defined memory address range relative to the memory address within the deterministic distance of the instruction in the binary module; and
processing information on the hardware tracing record if the pre-defined identifier is stored at the pre-defined memory address range relative to the memory address within the deterministic distance of the instruction.

2. The method of claim 1, wherein the memory address within the deterministic distance of the instruction is one of the exact address of the instruction that triggered the hardware tracing record, the address of the instruction that follows the instruction that triggered the hardware tracing record, or the address of an instruction at a pre-defined distance to the instruction that triggered the hardware tracing record.

3. The method according to claim 1, wherein the method comprises skipping a hardware tracing record if the determination, whether the pre-defined identifier is stored at the pre-defined memory address range, is negative.

4. The method according to claim 1, wherein the information on the hardware tracing record is processed with the custom information and with information on the binary module.

5. The method according to claim 1, wherein the hardware tracing record further comprises a timestamp, with the act of identifying the binary module being further based on the timestamp.

6. The method according to claim 1, wherein pre-defined identifier uniquely identifies a specific hardware tracing operation.

7. The method according to claim 1, wherein pre-defined identifier uniquely identifies a piece of software.

8. The method according to claim 7, wherein pre-defined identifier uniquely identifies a binary module of a piece of software.

9. The method according to claim 1, wherein the method is applied to a plurality of hardware tracing records stored in a pre-defined memory region.

10. The method according to claim 9, wherein the pre-defined memory region is a processor-specific hardware tracing buffer.

11. The method according to claim 9, wherein the pre-defined memory region is specified by the instruction having triggered the hardware tracing record, the method comprising skipping a hardware tracing record if the hardware tracing record is stored outside the pre-defined memory region.

12. The method according to claim 1, wherein the method is applied to at least one of a plurality of hardware tracing records retrieved over a transmission channel, and a plurality of hardware tracing records stored in a memory or storage device.

13. The method according to claim 1, wherein the hardware tracing record comprises information on a branch type, with the method comprising skipping the hardware tracing record unless the information on the branch type indicates an indirect branch.

14. A method for processing a piece of software, the method comprising:
processing the piece of software to identify a placement of one or more instructions for triggering creation of a hardware tracing record; and
inserting into the piece of software, for each instruction of the one or more instructions, a pre-defined identifier at a pre-defined memory address range relative to a memory address within a deterministic distance of the instruction.

15. The method according to claim 14, wherein the placement of the one or more instructions is identified by identifying at least one pre-defined instruction in an assembly code representation of the piece of software.

16. The method according to claim 14, wherein the placement of the one or more instructions is identified by identifying a pre-defined application programming interface call in a source code representation of the piece of software during compilation of the piece of software.

17. An apparatus comprising interface circuitry, machine-readable instructions and processor circuitry to execute the machine-readable instructions to perform the method according to claim 1.

18. An apparatus comprising interface circuitry, machine-readable instructions and processor circuitry to execute the machine-readable instructions to perform the method according to claim 14.

19. A non-transitory, computer-readable medium comprising a program code that, when the program code is executed on a processor, a computer, or a programmable hardware component, causes the processor, computer, or programmable hardware component to perform the method of claim 1.

20. A non-transitory, computer-readable medium comprising a program code that, when the program code is executed on a processor, a computer, or a programmable hardware component, causes the processor, computer, or programmable hardware component to perform the method of claim 14.
